(19) United States
(12) Patent Application Publication
(10) Pub. No.: US 2011/0240211 A1
(43) Pub. Date: Oct. 6, 2011

(54) METHOD FOR PRODUCING FUNCTIONAL FILM

(75) Inventor: Eijirou IWASE, Ashigarakami-gun (JP)

(73) Assignee: FUJIFILM CORPORATION, Tokyo (JP)

(21) Appl. No.: 13/075,747

(22) Filed: Mar. 30, 2011

(30) Foreign Application Priority Data
Mar. 30, 2010 (JP) 2010-078480

(51) Int. Cl. B29C 65/00

(52) U.S. Cl. 156/192

(57) ABSTRACT

A method for producing a functional film of one aspect of the presently disclosed subject matter includes: a step of continuously feeding a long support; a step of forming an inorganic film on a front surface side of the support under reduced pressure; and a step of winding the support on a roll under reduced pressure with a laminate film that imparts the slidability between the inorganic film and the support, the laminate film having a center line average roughness (Ra) equal to or less than a thickness of the inorganic film interposed between the inorganic film and the support.

### BACKGROUND OF THE INVENTION

1. Field of the Invention

The presently disclosed subject matter relates to a method for producing a functional film, in particular, a method for producing a functional film in which an inorganic film is formed on a support.

2. Description of the Related Art

In display devices such as an optical element, a liquid crystal display device and an organic electroluminescence display device, and various kinds of devices such as a semiconductor device and a thin film solar battery, various kinds of functional films such as a gas-barrier film, a protective film, an optical filter and optical films such as an anti-reflective film are used.

In order to efficiently produce functional films with high productivity secured, a so-called roll-to-roll technology where a film is continuously formed on a long support is adopted.

As an example of a method for producing functional films (for example, barrier films), Japanese Patent Application Laid-Open No. 2009-179853 discloses a method including coating an acrylate monomer or the like on a continuously running support, drying and curing a coated film, then winding the resultant on a roll, sending out the roll on which an organic film has been formed to a vacuum film deposition equipment to form an inorganic film on the organic film, and winding the resultant on a roll.

In a process of winding after forming an inorganic film in a vacuum film deposition equipment, a winding failure called winding wrinkles is generated. The winding wrinkle here generally means a wrinkle generated on a wound roll.

In a vacuum process, when a support having small twitching wrinkles immediately before winding is wound, there is no entrained air under a vacuum; accordingly, adhesiveness between a back surface of the support and a front surface of the inorganic film becomes higher. Accordingly, a force is difficult to escape to result in generating a winding wrinkle. In particular, when an organic film is formed before an inorganic film is formed, since smoothness of the support is improved, a more uniform inorganic film is formed. When the smoothness of the inorganic film is improved, the slidability disappears to result in remarkably generating wrinkles.

On the other hand, under atmospheric pressure, there is entrained air and thereby the support is smooth and slides in a width direction; accordingly, the winding wrinkle is resolved. Furthermore, Japanese Patent Application Laid-Open No. 2002-264274 discloses to insert a surface protective film having a thickness of 0.09 to 0.15 μm between optical members, followed by winding.

As described above, an advantage owing to the entrained air under atmospheric pressure cannot be expected under the vacuum. Furthermore, when a surface protective film according to Japanese Patent Application Laid-Open No. 2002-264274 is used, the inorganic film can be scratched.

### SUMMARY OF THE INVENTION

The presently disclosed subject matter has been made in view of these situations and provides a method for producing a functional film that can inhibit generation of winding wrinkles and reduce scratches to an inorganic film under reduced pressure.

One aspect of the presently disclosed subject matter provides a method for producing a functional film including: a step of continuously feeding a long support; a step of forming an inorganic film on a front surface side of the support under reduced pressure; and a step of winding the support on a roll under reduced pressure with a laminate film that imparts the slidability between the inorganic film and the support and has a center line average roughness (Ra) equal to or less than a thickness of the inorganic film interposed between the inorganic film and the support.

According to one aspect of the presently disclosed subject matter, the laminate film has a center line average roughness (Ra) that imparts slidability between the inorganic film and the support. Slidability is imparted thereby between the inorganic film and the support during winding so that generation of winding wrinkles can be inhibited. Furthermore, the laminate film has a center line average roughness (Ra) equal to or less than a thickness of the inorganic film. Scratching of the inorganic film can be thereby inhibited.

In another aspect of the presently disclosed subject matter, preferably, the inorganic film has a thickness from 20 nm to 150 nm and the laminate film has a center line average roughness (Ra) from 2 nm or more and 75 nm or less, or preferably 2 nm or more and 70 nm or less.

When the thickness of the inorganic film and the center line average roughness (Ra) of the laminate film are set in the above ranges, generation of winding wrinkles and scratches of the inorganic film can be more surely inhibited.

In another aspect of the presently disclosed subject matter, the laminate film preferably has a Young's modulus equal to or less than 6 Gpa. When the Young's modulus of the laminate film is set in the above range, the support can be readily wound on a roll.

In another aspect of the presently disclosed subject matter, preferably, a step of forming an organic film on a front surface side of the support is further included before a step of forming the inorganic film.

In another aspect of the presently disclosed subject matter, it is preferred that the laminate film is firstly stuck on a front surface side of the inorganic film, and the support is then wound on a roll. In another aspect of the presently disclosed subject matter, it is preferred that the laminate film is firstly stuck on a back surface side of the support, and the support is then wound on a roll.

Even when the laminate film is stuck on one of a front surface side of the inorganic film and a back surface side of the support, the laminate film can be interposed between the inorganic film and the support during winding.

In another aspect of the presently disclosed subject matter, the laminate film is preferably stuck on a back surface side of the support before the organic film is formed.

When the organic film is heated during a step of coating the organic film, adhesiveness between the laminate film and the support can be improved.

Another aspect of the presently disclosed subject matter provides a method for producing a functional film where the inorganic film preferably contains one selected from the group consisting of metals, metal oxides, metal nitrides, metal carbides, metal fluorides, and composite thereof.

Another aspect of the presently disclosed subject matter provides a method for producing a functional film where the organic film preferably contains one of radiation-curable monomer and oligomer.

According to a method for producing a functional film of the presently disclosed subject matter, under reduced pressure, generation of the winding wrinkles and scratches to the inorganic film can be reduced.

### BRIEF DESCRIPTION OF THE DRAWINGS

FIG. 1 is a constitutional diagram of a functional film;

FIGS. 2A and 2B are diagrams illustrating a state where the functional film is wound on a roll;

FIGS. 3A and 3B are diagrams illustrating an example of an equipment where a method for producing the functional film is carried out; and

FIGS. 4A and 4B are tables illustrating Examples.

### DETAILED DESCRIPTION OF THE PREFERRED EMBODIMENTS

Preferable embodiments of the presently disclosed subject matter will be described below with reference to the attached drawings. The presently disclosed subject matter will be described with reference to the following preferable embodiments. However, the embodiments can be variously modified by a large number of techniques and embodiments other than the embodiments can be used without deviating from the scope of the presently disclosed subject matter. Accordingly, all modifications in the scope of the presently disclosed subject matter are included in the scope of claims. Furthermore, in the specification, a range of numerical values expressed using “to” means a range that includes numerical values described before and after the “to”.

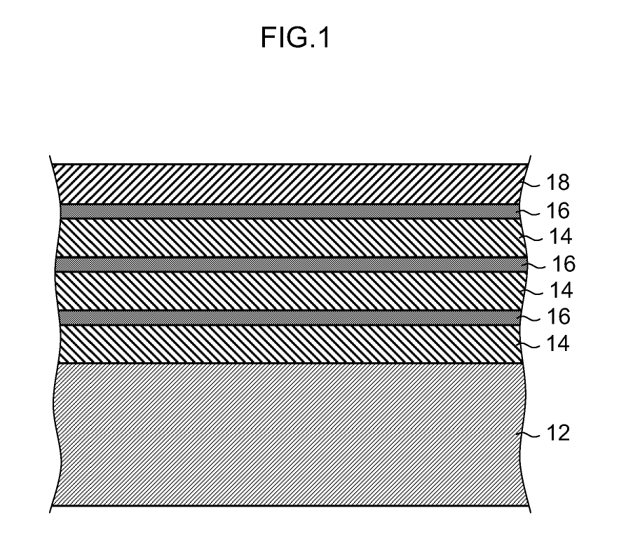

FIG. 1 illustrates a constitutional diagram of a functional film. A functional film 10 includes an organic film 14 formed on a front surface of a support 12 and an inorganic film 16 formed on the organic film 14. In the functional film 10, a combination of two layers of the organic film 14 and the inorganic film 16 as a repeating unit is repeated 3 times. The functional film 10 has an organic film 18 at the outer-most layer. The structure of the organic film 14 and the inorganic film 16 formed on a front surface side of the support 12 is not restricted to the above structure. An inorganic film and an organic film can be formed in this order on a front surface side of the support 12.

The support 12 is not particularly restricted as long as the organic film 14 can be formed thereon, and the inorganic film 16 can be formed by vacuum deposition thereon. Various kinds of supports used in functional films such as various kinds of resin films such as PET (polyethylene terephthalate) films and various kinds of metal sheets such as aluminum sheets can be used.

Examples of the organic films 14 include all films that can be formed before the inorganic film is formed, such as an anchor coat layer for improving the adhesiveness, an oxide film formed by atmospheric plasma and a heat-curable or UV-curable organic film. The inorganic film 16 preferably includes at least one metal, metal oxide, metal nitride, metal carbide, metal fluoride or composite thereof.

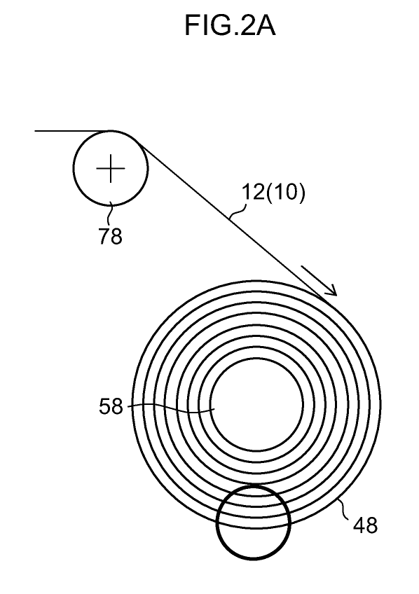

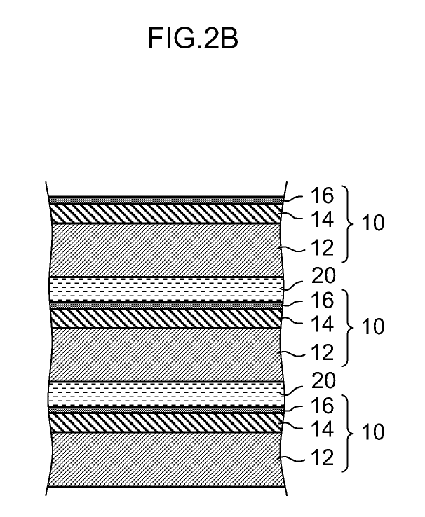

FIGS. 2A and 2B illustrate a state where a functional film is wound on a film roll in a winding chamber of a vacuum film deposition equipment. The support 12 (functional film 10) on which the organic film 14 and the inorganic film 16 are formed is guided by a guide roller 78 to a winder 58. The support 12 is wound on a film roll 48 by the winder 58. As illustrated in a partially enlarged diagram (FIG. 2B), the functional film 10 includes the support 12, the organic film 14 and the inorganic film 16. A constitution of the functional film 10 is not restricted thereto.

By winding in roll, a back surface side of the support 12 and a front surface side of the inorganic film 16 are in an opposite positional relationship (the back surface of the support 12 and the front surface of the inorganic film 16 are faced each other). In the embodiment, a laminate film 20 is disposed between the support 12 and the inorganic film 16. The laminate film 20 has a center line average roughness (Ra) from 2 nm to 70 nm; accordingly, a contact area between the laminate film 20 and the support 12 or between the laminate film 20 and the inorganic film 16 can be made smaller. As the result, friction resistances therebetween respectively can be made smaller and the slidability can be thereby improved. Here, the center line average roughness (Ra) is defined in terms of an average value obtained by measuring a front surface roughness of a laminate and averaging peaks and peaks of concaves and convexes thereof. The front surface roughness of the laminate film 20 is based on the center line average roughness (Ra) obtained by measuring in the range of 10 μm by atomic force microscopy.

Furthermore, a value of the center line average roughness (Ra) of the laminate film 20 is smaller than a thickness of the inorganic film 16. In particular, the adhesiveness between the functional film 10 and the laminate film 20 becomes larger under reduced pressure during winding a film. In the case where a value of the center line average roughness (Ra) is larger than a thickness of the inorganic film 16, there is concern that concavity and convexity of the laminate film 20 may scratch or destroy the inorganic film 16. Accordingly, the laminate film 20 having a center line average roughness (Ra) that can impart slidability and inhibit scratching of the inorganic film under reduced pressure is used. Examples of the usable laminate films 20 include films made of polyethylene (PE), polyethylene terephthalate (PET) and polyethylene naphthalate (PEN).

When a laminate film itself contains a filler or spherical particles or a layer containing such particles is provided on a front surface, a center line average roughness (Ra) of a front surface of the laminate film 20 can be from 2 nm to 70 nm.

The laminate film 20 may be present between the support 12 and the inorganic film 16 after forming the inorganic film 16 and before winding in roll. The inorganic film 16 can be formed with the laminate film 20 stuck to a back surface of the support 12 and wound in roll. In this case, the support 12 with the laminate film 20 may be prepared. After the inorganic film 16 is formed, the laminate film 20 may be stuck on a back surface of the support 12 or on a front surface of the inorganic film 16.

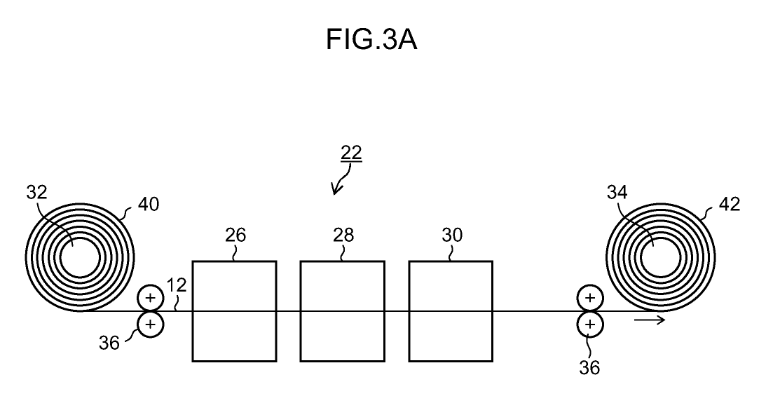

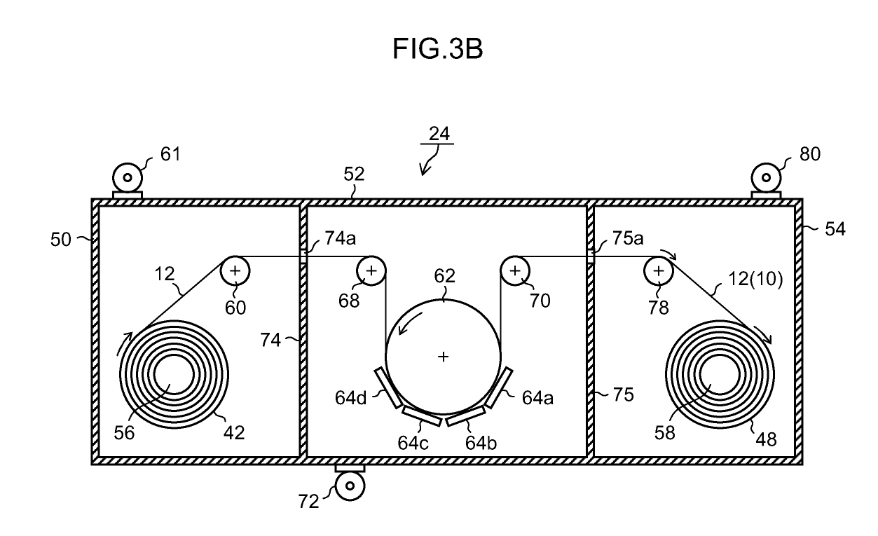

A method for producing a functional film and a production equipment will be described with reference to FIGS. 3A and 3B. The production equipment for producing a functional film includes an organic film deposition equipment 22 for forming an organic film on a front surface of the support 12 and a vacuum film deposition equipment 24 for forming an inorganic film on the organic film.

FIG. 3A conceptually illustrates an example of the organic film deposition equipment 22. The organic film deposition equipment 22 includes a feeding out mechanism 32, a coating device 26, a heating device 28, a UV-irradiating device 30, and a winder 34. The organic film deposition equipment 22 forms an organic film between the feeding out mechanism 32 and the winder 34 by roll-to-roll deposition.

In the organic film deposition equipment 22, firstly, the feeding out mechanism 32 is loaded with a film roll 40. Then, with a take-off roller 36, the support 12 is conveyed from the film roll 40 in a longitudinal direction. The coating device 26 is used to coat, for example, a coating solution containing a previously prepared radiation-curable monomer or an oligomer on the support 12. The heating device 28 is used to dry the coating solution to evaporate a solvent. The UV-irradiating device 30 is used to irradiate UV-rays (ultraviolet) to a dried coating solution to start a polymerization reaction. The coating solution is cured to form an organic film on the support 12.

According to the embodiment, a laminate film in which slidability is imparted between the inorganic film and the support and which has a center line average roughness (Ra) equal to or less than a thickness of the inorganic film is stuck to a back surface of the support 12. Thereby, the film roll 40 around which the support 12 with the laminate film is wound is prepared.

The support 12 on which an organic film is formed is wound by the winder 34 as the film roll 42. At this time, winding tension of the support 12 is controlled. When an organic film is heated during the coating step, the adhesiveness between the laminate film and the support 12 can be improved.

In particular, when the adhesiveness between the support and the laminate film is poor, residual air between the support and the laminate film expands under vacuum. As a result, the adhesiveness with a film deposition drum of a vacuum film deposition equipment is damaged and the inorganic film may not be thereby uniformly formed in some cases. Accordingly, the adhesiveness between the laminate film and the support is preferably improved.

As illustrated in FIG. 3B, the vacuum film deposition equipment 24 conducts roll-to-roll deposition, like with the organic film deposition equipment 22. The support 12 is fed out from the film roll 42 with a feeding out mechanism 56. While transporting the support 12 in a longitudinal direction, an inorganic film is formed on the organic film on the support 12. The support 12 on which a laminate constituted of the organic film and the inorganic film is formed is wound on a film roll 48 with the winder 58. The vacuum film deposition equipment 24 includes a feeding chamber 50, a film deposition chamber 52 and a winding chamber 54.

The film roll 42 around which the support 12 on which the organic film is formed is wound is loaded in the feeding chamber 50 of the vacuum film deposition equipment 24. The feeding chamber 50 includes the feeding out mechanism 56, a guide roller 60 and an evacuation device 61. The film roll 42 around which the support 12 provided with the organic film is wound is loaded to the feeding out mechanism 56 of the feeding chamber 50. The support 12 is fed out of the film roll 42, goes through a slit 74a of a partition wall 74 and is conveyed from the feeding chamber 50 to the film deposition chamber 52. Within the feeding chamber 50, the feeding out mechanism 56 is rotated in a clockwise direction in the drawing with a driver not illustrated. The support 12 is conveyed with the guide roller 60 from the film roll 42 via a predetermined path to the film deposition chamber 52.

The feeding chamber 50 is provided with the evacuation device 61. By the evacuation device 61, the inside of the feeding chamber 52 is depressurized to pressure predetermined in response to film deposition pressure in the film deposition chamber 52. Thereby, pressure of the feeding chamber 50 is inhibited from adversely affecting on pressure (film deposition) of the film deposition chamber 52. As the evacuation device 61, a known device can be used as with an evacuation device 72 of the film deposition chamber 52 described below.

The support 12 is guided by the guide roller 60 and conveyed to the film deposition chamber 52. In the film deposition chamber 52, an inorganic film is formed on a front surface of the support 12, that is, on a front surface of the organic film. As illustrated in FIG. 3B, the film deposition chamber 52 includes a drum 62, film deposition devices 64a, 64b, 64c and 64d, guide rollers 68 and 70, and an evacuation device 72. When a film is deposited by sputtering, plasma CVD (chemical vapor deposition) in the film deposition chamber 52, or the like, the film deposition chamber 52 is further provided with a high-frequency power supply or the like.

The drum 62 of the film deposition chamber 52 is rotated with a center line as a center in an anticlockwise direction in the drawing with a driver not illustrated. The support 12 guided to the predetermined path with the guide roller 68 is wound around in a predetermined region on a peripheral surface of the drum 62 and conveyed via a predetermined conveying path while being supported/guided with the drum 62. During the process, an inorganic film is formed on the organic film with the film deposition devices 64a to 64d. The inorganic film formed at this time desirably has a thickness from 5 nm to 200 nm.

The film deposition devices 64a to 64d form an inorganic film on a front surface of the support 12 according to a vacuum film deposition method. Examples of the film deposition devices that can be used includes all of known vacuum film deposition methods (vapor phase deposition method) such as CVD, plasma CVD, sputtering, vacuum evaporation and ion plating, without restricting thereto.

Accordingly, the film deposition devices 64a to 64d are constituted of various members corresponding to a vacuum film deposition method being executed. For example, when the film deposition chamber 52 forms an inorganic film by ICP-CVD (Inductively Coupled Plasma CVD), the film deposition devices 64a to 64d can include an induction coil for forming an induction magnetic field and a gas feeding device for feeding a reactive gas to a film deposition region.

Furthermore, when the film deposition chamber 52 forms an inorganic film by CCP-CVD (Capacitively Coupled Plasma CVD), the film deposition devices 64a to 64d can include a high frequency electrode that is hollow, has many small holes on a surface facing the drum 62 and is communicated with a feed source of a reactive gas and a shower electrode that acts as a reactive gas feeding device.

Still furthermore, when the film deposition chamber 52 forms an inorganic film by vapor phase film deposition according to a CVD method, the film deposition devices 64a to 64d can include an introducing device of a reactive gas.

Furthermore, when the film deposition chamber 52 forms an inorganic film by sputtering, the film deposition devices 64a to 64d can include a holding device of a target, a high-frequency electrode and a feeding device of a sputtering gas or the like.

The evacuation device 72 evacuates the inside of the film deposition chamber 52 to achieve a degree of vacuum in accordance with the film deposition of an inorganic film by vacuum film deposition. The evacuation device 72 is not particularly restricted. Various kinds of known (vacuum) evacuation devices used in vacuum film deposition equipments that use a vacuum pump such as a turbo pump, a mechanical booster pump or a rotary pump, an auxiliary device such as a cryo-coil and a device for controlling the ultimate vacuum or an exhaust amount can be used.

The support 12 on which an inorganic film has been formed with the film deposition devices 64a to 64d is guided to a slit 75a of a partition wall 75 with the guide rollers 70 and 78 and conveyed to the winding chamber 54. The winding chamber 54 is provided with an evacuation device 80. By the evacuation device 80, the inside of the winding chamber 54 is depressurized so as to be predetermined pressure. By the winder 58 disposed inside of the winding chamber 54, the support 12 is wound around the film roll 48.

The laminate film stuck to a back surface side of the support 12 has the center line average roughness (Ra) that imparts the slidability between the inorganic film and the support. Slidability is thereby imparted between the inorganic film and the support during winding; accordingly, the winding wrinkles can be inhibited from being generated. Furthermore, the laminate film has the center line average roughness (Ra) equal to or less than a thickness of the inorganic film. Thereby, the inorganic film can be inhibited from being scratched.

In general, when the winding wrinkles are generated, during use as a product, when a film roll is unwound, traces of folding remain on the support. The traces of folding may cause defective appearance quality of the product and destroy the inorganic film by folding to result in deteriorating product performance. According to the embodiment, the winding wrinkles can be inhibited from being generated; accordingly, these problems can be solved.

To the feeding chamber 50, conveyance devices for conveying the support 12 along a predetermined path such as a pair of conveyance rollers and a guide member that controls a position in a width direction of the support 12 may be provided in addition to illustrated members.

Then, the film roll 48 is set to the feeding out mechanism 32 of the organic film deposition equipment 22 as a film roll 40 and an organic film is formed on the inorganic film. The support 12 on which an organic film/an inorganic film/an organic film are formed is wound with the winder 34 as the film roll 42.

In the next place, the film roll 42 is loaded to the feeding chamber 50 of the vacuum film deposition equipment 24. An inorganic film is formed on the support 12. After a plurality of times of film deposition steps of organic film and a plurality of times of film deposition steps of inorganic film, a desired functional film is produced.

When an organic material and an inorganic material, respectively, are repeatedly deposited three times, followed by depositing an organic material on the outermost layer, a functional film illustrated in FIG. 1 is produced.

After predetermined organic film/inorganic film are deposited on the support, the laminate film can be peeled off the support. In order to protect the back surface of the support from a solvent, the laminate film is stuck to a back surface of the support. Accordingly, when the film deposition step comes to an end, the laminate film can be peeled.

As a material of the organic film, any of materials that allow to use, for example, an anchor coat layer for improving the adhesiveness, an oxide film that is deposited by atmospheric plasma and a thermosetting or UV-curable organic film before deposition of the inorganic film can be used.

For example, specifically, as a monomer or oligomer being used, a monomer or oligomer that has two or more ethylenically unsaturated double-bonds and is addition-polymerized under irradiation of light is desirable.

For example, when a UV-curable resin is applied as an organic film, the mechanical strength and the surface smoothness can be improved. When a mixed solution of a mixture of 15 g of polymerizable monomer (trade name: BEPGA, manufactured by Kyoeisha Chemical Co., Ltd.) and 5 g of polymerizable monomer (trade name: V-3PA, manufactured by Osaka Organic Chemical Industry Ltd.) as an example of UV-curable resin, 1.5 g of UV-polymerizable initiator (trade name: ESACURE KTO-46, manufactured by Lamberti S.P.A.) and 190 g of 2-butanone is coated on a support, an organic film can be formed.

Furthermore, in place of BEPGA or V-3PA, also an acryl monomer: KAYARAD DPHA (trade name, manufactured by Nippon Kayaku Co., Ltd.) or KAYARAD TMPTA (trade name, manufacture by Nippon Kayaku Co., Ltd.) can be used.

When, for example, a thermosetting resin is applied as an organic film, the adhesiveness can be improved. When a thermosetting resin (epoxy resin: EPICLON 840-S (trade name, manufactured by DIC Co., Ltd. (bisphenol A liquid)) as an example of the thermosetting resin is diluted with methyl ethyl ketone so as to adjust a solid content at 5%, followed by coating on a support, an organic film can be obtained. Furthermore, other than the above, a polyester resin (trade name: VYLON 200, manufactured by Toyobo Co., Ltd.) can be used.

As a method for depositing an organic film, a usual solution coating method can be cited. Examples of the solution coating methods include a dip coat method, an air knife coat method, a curtain coat method, a roller coat method, a wire bar coat method, a gravure coat method, a slide coat method or an extrusion coat method that uses a hopper, which is described in U.S. Pat. No. 2,681,294, which can be used for application.

When, for example, as a functional film, a gas barrier film (water vapor barrier film) is produced, as an inorganic film, a silicon nitride film, an aluminum oxide film, a silicon oxide film or the like is desirably formed.

When a protective film of various kinds of devices and equipments such as display devices including organic electroluminescence displays and liquid crystal displays is produced by a functional film, a silicon oxide film or the like is desirably formed as an inorganic film.

Furthermore, when a functional film such as an anti-light-reflective film, a light reflecting film or various kinds of filters is produced, a film made of a material having or developing target optical characteristics is desirably formed as an inorganic film.

A method for producing a functional film of the presently disclosed subject matter was described in detail in the above. However, the presently disclosed subject matter is not restricted to the embodiments and, in the range not deviating from the gist of the presently disclosed subject matter, can be variously improved or modified.

### EXAMPLES

In what follows, the presently disclosed subject matter will be more specifically described with reference to Examples. Materials, use amounts, ratios, processing contents, and processing procedures illustrated in the following Examples can be appropriately modified as long as the modification does not deviate from the gist of the presently disclosed subject matter. Accordingly, the range of the presently disclosed subject matter is not restricted to specific examples illustrated below.

As a support, a polyethylene terephthalate (PET) base having a width of 1000 mm and a thickness of 50 μm was used. Several kinds of laminate films having different front surface roughness were prepared.

As to the front surface roughness of the laminate film, the center line average roughness (Ra) measured with an AFM in the range of 10 μm was used as a basis. As to the hardness of the laminate film, the Young's modulus of a material being used was used as a basis. The scratches generated on the inorganic film were determined based on a property (moisture permeability) affected by damaging.

Firstly, an acrylate monomer and a photopolymerization initiator were dissolved in an organic solvent, followed by coating on a support with a die coater. A coated film was dried and further cured by UV-curing, and thereby an organic film was formed on the support. While controlling so that the winding tension may be constant in response to a winding diameter, a film roll was prepared. By controlling a flow rate of a liquid to the support, a thickness of the organic film was controlled so as to be 1 μm in a completely cured state.

Thereafter, the film roll was set to a vacuum film deposition equipment. After the vacuum film deposition equipment was evacuated, an inorganic film (alumina film) was formed at a thickness from 20 to 150 nm on a front surface of the organic film by reactive sputtering. After the film deposition, under reduced pressure, the support was wound in roll with a winder at the winding tension of 50 (N/m).

The performance of a produced functional film was evaluated with the moisture permeability. The moisture permeability was evaluated based on criteria illustrated in Table 1.

TABLE 1

| | Evaluation |
|---|---|
| Barrier performance (moisture permeability) | criteria |
| 1.0 × 10⁻³ g/m² · day or more | D |
| 2.0 × 10⁻⁴ g/m² · day or more and less than 1.0 × 10⁻³ g/m² · | C |
| day | |
| 1.0 × 10⁻⁴ g/m² · day or more and less than 2.0 × 10⁻⁴ g/m² · | B |
| day | |
| Less than 1.0 × 10⁻⁴ g/m² · day | A |

A: Excellent
B: Good
C: Fair
D: Poor

A degree of the winding wrinkles caused by winding after the deposition of the inorganic film was confirmed by visual evaluation. The visual evaluation was based on Table 2.

TABLE 2

| | Evaluation |
|---|---|
| Winding wrinkle | criteria |
| A plurality of strong winding wrinkles was generated on the | D |
| film roll. When the film roll was unwound, traces of folding | |
| of the support were found. | |
| Weak winding wrinkles were generated on the film roll. | C |
| When the film roll was unwound, traces of folding of the | |
| support were slightly found. | |
| A winding wrinkle was not visually found on the film roll. | B |
| When the film roll was unwound, traces of folding of the | |
| support were hardly found. | |
| A winding wrinkle was not visually found on the film roll. | A |
| When the film roll was unwound, traces of folding of the | |
| support were not found. | |

A: Excellent
B: Good
C: Fair
D: Poor

The traces of folding (a concave-shaped curved trace was generated on the support, the strength or curvature of the trace) were visually evaluated. Visual evaluation was carried out by spreading a film on a smooth table and light reflection from a front surface thereof was observed. When there is a trace of folding, a concave-shaped non-uniformity is observed owing to curving of light.

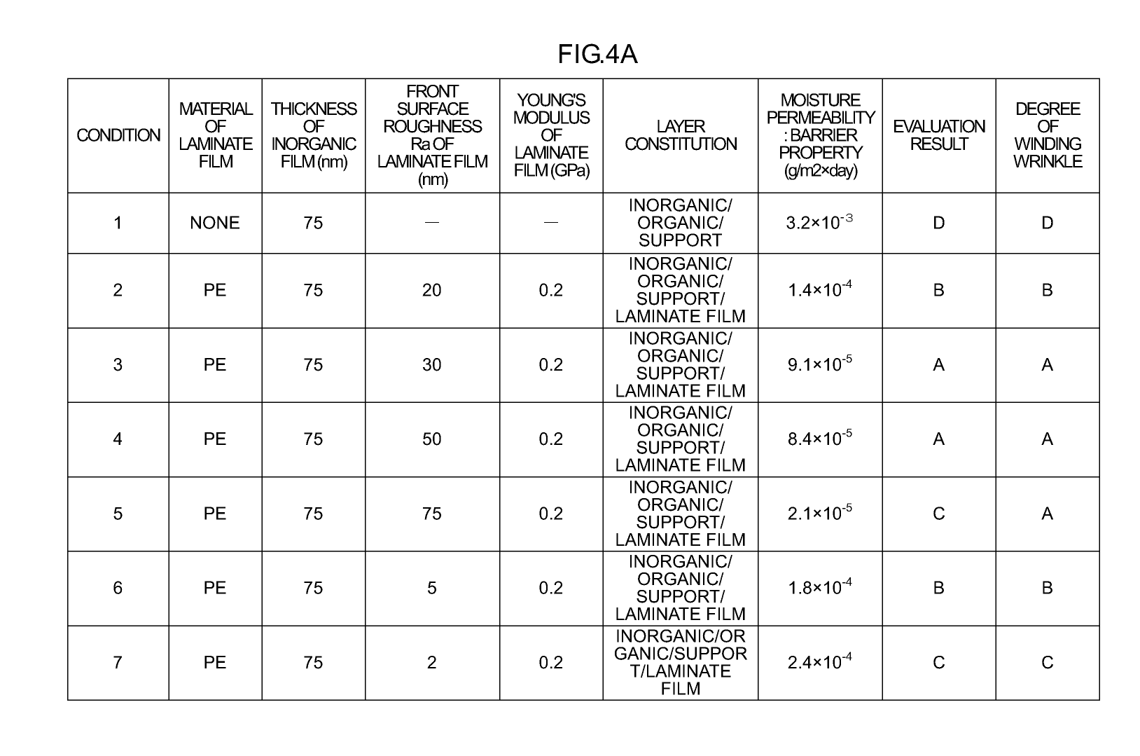

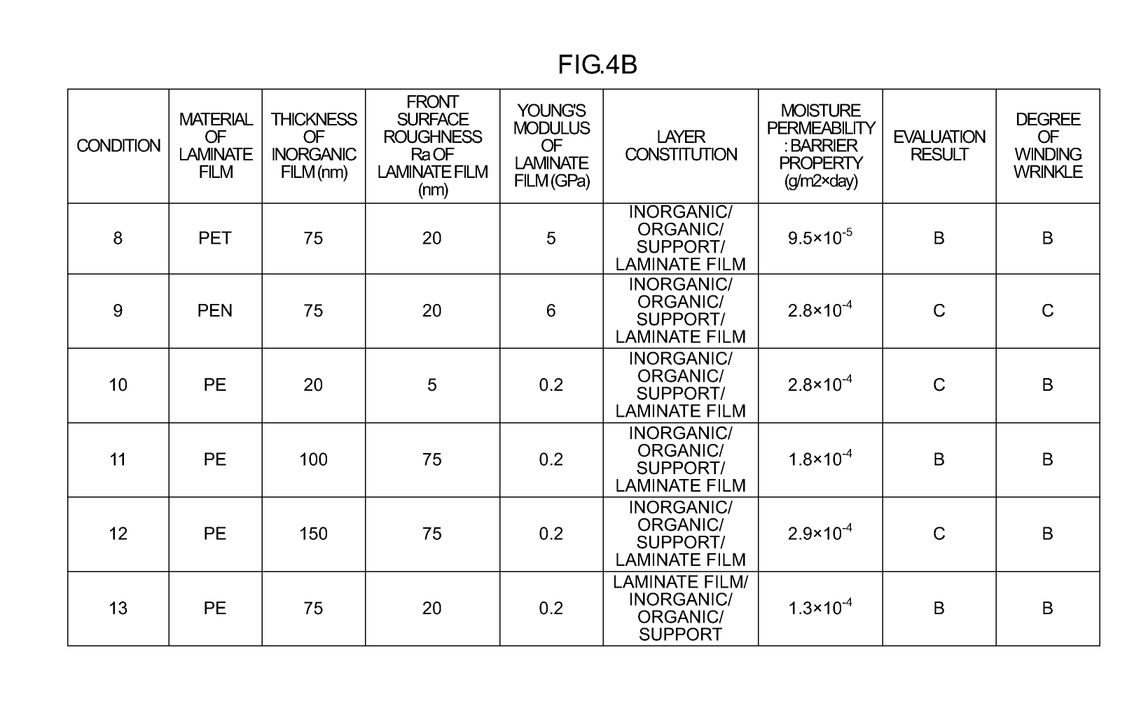

Tables of FIGS. 4A and 4B summarize supports, and conditions of laminate films, and evaluation results of conditions 1 to 13.

### [Condition 1]

A laminate film was not stuck to a back surface of a support. On a front surface of the support, an organic film and an inorganic film were deposited in this order.

### [Condition 2]

A PE laminate film having the center line average roughness (Ra) of 20 nm was stuck to a back surface of a support. The Young's modulus was set to 0.2 (GPa). On a front surface of the support, an organic film and an inorganic film were deposited in this order. A thickness of the inorganic film was set to 75 nm.

### [Condition 3]

Except that the center line average roughness (Ra) of the laminate film was set to 30 nm, conditions the same as the condition 2 were adopted.

### [Condition 4]

Except that the center line average roughness (Ra) of the laminate film was set to 50 nm, conditions the same as the condition 2 were adopted.

### [Condition 5]

Except that the center line average roughness (Ra) of the laminate film was set to 75 nm, conditions the same as the condition 2 were adopted.

### [Condition 6]

Except that the center line average roughness (Ra) of the laminate film was set to 5 nm, conditions the same as the condition 2 were adopted.

### [Condition 7]

Except that the center line average roughness (Ra) of the laminate film was set to 2 nm, conditions the same as the condition 2 were adopted.

### [Condition 8]

A PET laminate film having the center line average roughness (Ra) of 20 nm was stuck to a back surface of the support. The Young's modulus was set to 5 (GPa). On a front surface of the support, an organic film and an inorganic film were deposited in this order. A thickness of the inorganic film was set to 75 nm

### [Condition 9]

A PEN laminate film having the center line average roughness (Ra) of 20 nm was stuck to a back surface of the support. The Young's modulus was set to 6 (GPa). On a front surface of the support, an organic film and an inorganic film were deposited in this order. A thickness of the inorganic film was set to 75 nm

### [Condition 10]

Except that a thickness of the inorganic film was set to 20 nm and the center line average roughness (Ra) was set to 5 nm, conditions the same as the condition 2 were adopted.

### [Condition 11]

Except that a thickness of the inorganic film was set to 100 nm and the center line average roughness (Ra) was set to 75 nm, conditions the same as the condition 2 were adopted.

### [Condition 12]

Except that a thickness of the inorganic film was set to 150 nm and the center line average roughness (Ra) was set to 75 nm, conditions the same as the condition 2 were adopted.

### [Condition 13]

Except that the inorganic film was stuck on a front surface of the PE laminate film, conditions the same as the condition 2 were adopted.

### EVALUATION

Since the condition 1 did not have the laminate film, both the evaluation result and the degree of winding wrinkle were evaluated as poor (D). In each of the conditions 2 to 4 and 6, the center line average roughness (Ra) of the laminate film was 2 nm or more and equal to or less than a film thickness of the inorganic film. As the result thereof, both the evaluation result and a degree the winding wrinkle were evaluated as good (B) or better than good (A). In the condition 5, the center line average roughness (Ra) was almost the same as a film thickness of the inorganic film. Accordingly, during winding, feed-through to the inorganic film occurred owing to the roughness, the barrier property was deteriorated and thereby the evaluation result was fair (C).

In the condition 7, the center line average roughness (Ra) of the laminate film was 2 nm. Both the evaluation result and the degree of winding wrinkle were fair (C). From the result, it is inferred that, when the center line average roughness (Ra) is smaller than 2 nm, the slidability is not exerted, and thereby the winding wrinkles are generated.

In the conditions 8 and 9, irrespective of material of the laminate film, both the evaluation result and degree of winding wrinkles were evaluated as equal to or better than fair (C). When the Young's modulus of the laminate film exceeds 6 (GPa), the laminate film becomes hard. As the result, it is inferred that the winding cannot be excellently performed.

In the condition 10, a thickness of the inorganic film was 20 nm and thereby the barrier property was found deteriorated. However, since the center line average roughness (Ra) was 5 nm, the degree of winding wrinkle was evaluated as good (B).

In the condition 11, a film thickness of the inorganic film was 100 nm; accordingly, even when the center line average roughness (Ra) was 75 nm, the barrier property was evaluated as good (B). The degree of winding wrinkles was evaluated as good (B).

In the condition 12, a thickness of the inorganic film was 150 nm. Accordingly, during winding on a film roll, the inorganic film itself was broken. The barrier property was found deteriorated and the evaluation was fair (C).

In the condition 13, the laminate film was stuck to the inorganic film. Also by winding in this state in a film form, the laminate film can be interposed between the inorganic film and the support. Accordingly, both the barrier property and degree of winding wrinkles were evaluated as good (B). That is, it can be understood that the result does not depend on a position where the laminate film is stuck.

What is claimed is:

1. A method for producing a functional film, comprising:
a step of continuously feeding a long support;
a step of forming an inorganic film on a front surface side of the support under reduced pressure; and
a step of winding the support on a roll under reduced pressure with a laminate film that imparts the slidability between the inorganic film and the support and has a center line average roughness (Ra) equal to or less than a thickness of the inorganic film interposed between the inorganic film and the support.

2. The method for producing a functional film according to claim 1, wherein
the inorganic film has a thickness of 20 nm or more and 150 nm or less, and the laminate film has a center line average roughness (Ra) of 2 nm or more and 75 nm or less.

3. The method for producing a functional film according to claim 1, wherein
the laminate film has a Young's modulus equal to or less than 6 Gpa.

4. The method for producing the functional film according to claim 1, further comprising:
a step of forming an organic film on a front surface side of the support before the step of forming an inorganic film.

5. The method for producing a functional film according to claim 1, wherein
the support is wound on a roll after the laminate film is stuck onto a front surface side of the inorganic film.

6. The method for producing a functional film according to claim 1, wherein
the support is wound on a roll after the laminate film is stuck onto a back surface side of the support.

7. The method for producing a functional film according to claim 6, wherein
the laminate film is stuck to a back surface side of the support, before the organic film is formed.

8. The method for producing a functional film according to claim 1, wherein
the inorganic film contains one selected from the group consisting of metal, metal oxides, metal nitrides, metal carbides, metal fluorides, and composites thereof.

9. The method for producing a functional film according to claim 4, wherein
the organic film contains one of radiation-curable monomer and oligomer.
